(19) United States
(12) Patent Application Publication
(10) Pub. No.: US 2014/0199671 A1
(43) Pub. Date: Jul. 17, 2014

(54) Classroom Management and Educational System and Method

(71) Applicants: Christina Hippeli, Jacksonville, FL (US); Ben Hippeli, Jacksonville, FL (US)

(72) Inventors: Christina Hippeli, Jacksonville, FL (US); Ben Hippeli, Jacksonville, FL (US)

(21) Appl. No.: 13/744,375

(22) Filed: Jan. 17, 2013

(51) Int. Cl. G09B 19/00

(52) U.S. Cl. CPC G09B 19/00
USPC 434/236

(57) ABSTRACT

A classroom management and educational system and method, including accessing a database including a plurality of student behavior accounts, authenticating an authorized administrative user, accepting one or more modifications by the authorized administrative user to a selected student behavior account selected from the plurality of student behavior accounts, authenticating an authorized student user, accepting one or more operations by the authorized student user, modifying a student behavior account associated with the authorized student user in the database based on the one or more operations, and generating a plurality of conduct reports based on a plurality of purchased conduct grades. The one or modifications are selected from crediting the selected student behavior account and billing the selected student behavior account. The one or more operations are selected from paying a bill with credits and purchasing a conduct grade with credits.

### BACKGROUND OF THE INVENTION

1. Field of the Invention

The present invention relates to the field of education. More specifically, the present invention is directed to classroom management and educational systems and methods.

2. Description of the Related Art

Teacher or administrators all search for the ideal classroom management system. regardless of what they chose, it always results in more paperwork and one more system to create and maintain.

Most teachers or administrators would benefit from a classroom management system that promotes good classroom behavior by holding students accountable for their actions, allows teachers or administrators to immediately communicate positive and negative behavior to parents and administrators, requires students to utilize their academic skills while at the same time teaching real life applicable tools, such as managing money and budgeting, and provides a seamless network of adult cooperation for each student.

To overcome the problems and limitation described above, there is a need for a classroom management and educational systems and methods that addresses these limitations.

### BRIEF SUMMARY OF THE INVENTION

The classroom management and educational systems and methods described herein enable the coordination of the teacher, student, parent and even administrator. Through the use of online checking accounts, students are rewarded and penalized for their classroom behavior. Throughout each school day, the teacher updates an online system which stores data specific to each student and which keeps students, parents and administrators informed of a student's classroom behavior.

One or more embodiments of the classroom management and educational systems and methods described herein enable a computer-readable medium including computer-readable instructions for a classroom management system. Execution of the computer-readable instructions by one or more processors causes the one or more processors to execute steps including accessing a database including a plurality of student behavior accounts.

The steps further include authenticating an authorized administrative user and accepting one or more modifications by the authorized administrative user to a selected student behavior account selected from the plurality of student behavior accounts. The one or more modifications are selected from crediting the selected student behavior account and billing the selected student behavior account.

The steps further include authenticating an authorized student user and accepting one or more operations by the authorized student user. The one or more operations are selected from paying a bill with credits and purchasing a conduct grade with credits.

In one or more embodiments, the steps further include notifying a guardian party associated with the authorized student user when a conduct grade is purchased.

The steps further include modifying a student behavior account associated with the authorized student user in the database based on the one or more operations.

The steps further include generating a plurality of conduct reports based on a plurality of purchased conduct grades.

In one or more embodiments, the steps further include authenticating an authorized guardian user associated with a student user and providing information stored in the database in a student behavior account associated with the student user to the authorized guardian user. The information may include a conduct grade purchased by the student user. The information may also include historical classroom behavior data.

The steps may further include providing a guardian user interface to the authorized guardian user. An administrative user interface may be provided to the authorized administrative user. Furthermore, a student user interface may be provided to the authorized student user.

The computer-readable medium of claim 1, where the one or more modifications are further selected from adding a student, removing a student, clearing a student behavior account, and assigning an association between a student behavior account and one or more authorized administrative user.

The computer-readable medium of claim 1, where the one or modifications are further selected from adding a student, removing a student, clearing a student behavior account, and assigning an association between a student behavior account and one or more authorized administrative user.

The computer-readable medium of claim 10, where the student user interface includes an interactive checking account ledger.

One or more embodiments of the classroom management and educational systems and methods described herein enable a classroom management system.

The classroom management system has a behavior data module configured to store a plurality of student behavior accounts in a database. The student behavior accounts include credits earned by an associated student and bills charged to the associated student.

The classroom management system also has a teacher or administrator access module configured to accept one or more modifications to a selected student behavior account. The one or more modifications are selected from crediting the selected student behavior account and billing the selected student behavior account. In one or more embodiments, the one or more modifications are further selected from adding a student, removing a student, clearing a student behavior account, and assigning an association between a student behavior account and one or more authorized administrative user.

The classroom management system also has a student access module configured to accept one or more operations. The one or more operations are selected from paying a student bill with credits from a student behavior account and purchasing a conduct grade with credits. In one or more embodiments, a guardian party is notified when a conduct grade is purchased. The student access module may include user interface including an interactive checking account ledger.

In one or more embodiments, the student access module is further configured to verify a manually computed checking account ledger.

In one or more embodiments, the classroom management system further includes a guardian access module configured to provide information stored in the database in an associated student behavior account to a guardian user. The information may include a conduct grade purchased by the student user. The information may also include historical classroom behavior data.

### BRIEF DESCRIPTION OF THE DRAWINGS

The above and other aspects, features and advantages of the classroom management and educational systems and methods described herein will be more apparent from the following more particular description thereof, presented in conjunction with the following drawings wherein:

FIG. 1 illustrates a flowchart corresponding to an exemplary student user interface in accordance with classroom management and educational systems and methods described herein. More specifically, this figure illustrates the steps undergone when a teacher bills the student for a specific behavior.

FIG. 2 illustrates a flowchart corresponding to an exemplary student user interface in accordance with classroom management and educational systems and methods described herein. More specifically, this figure illustrates the steps undergone when a teacher bonuses the student for a specific behavior.

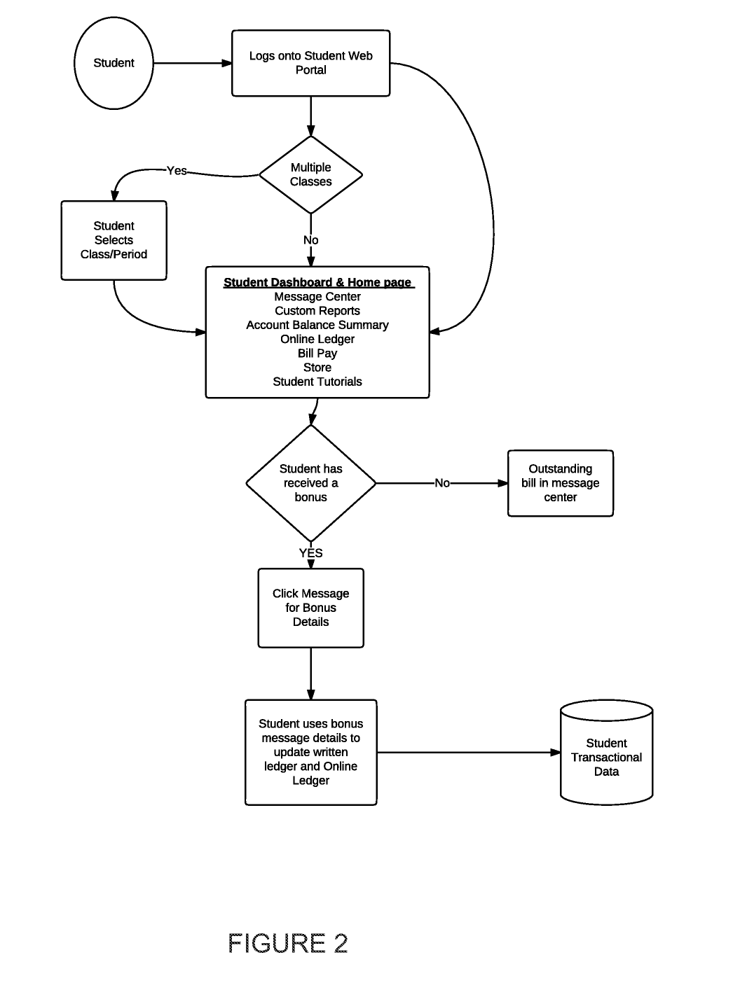

FIG. 3 illustrates a flowchart corresponding to an exemplary student user interface in accordance with classroom management and educational systems and methods described herein. More specifically, this figure illustrates the steps undergone at the end of each period

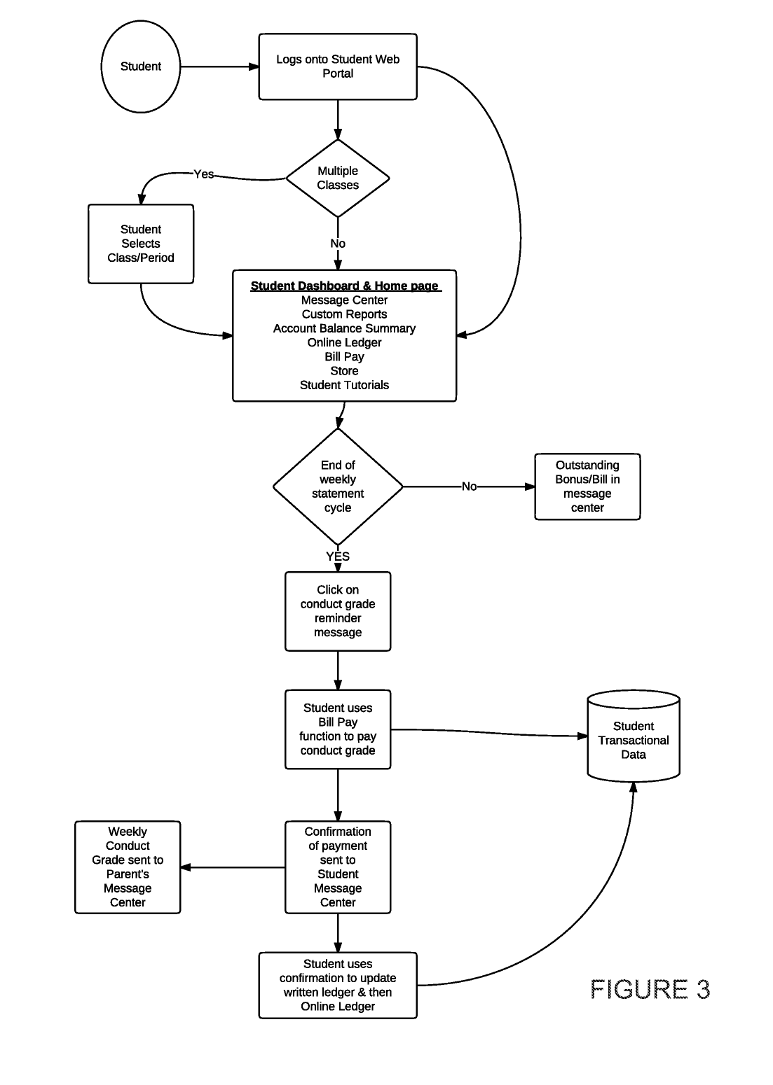

FIG. 4 illustrates a flowchart corresponding to an exemplary administrative user interface in accordance with classroom management and educational systems and methods described herein. More specifically, this figure illustrates the steps undergone when a teacher logs onto the teacher portal.

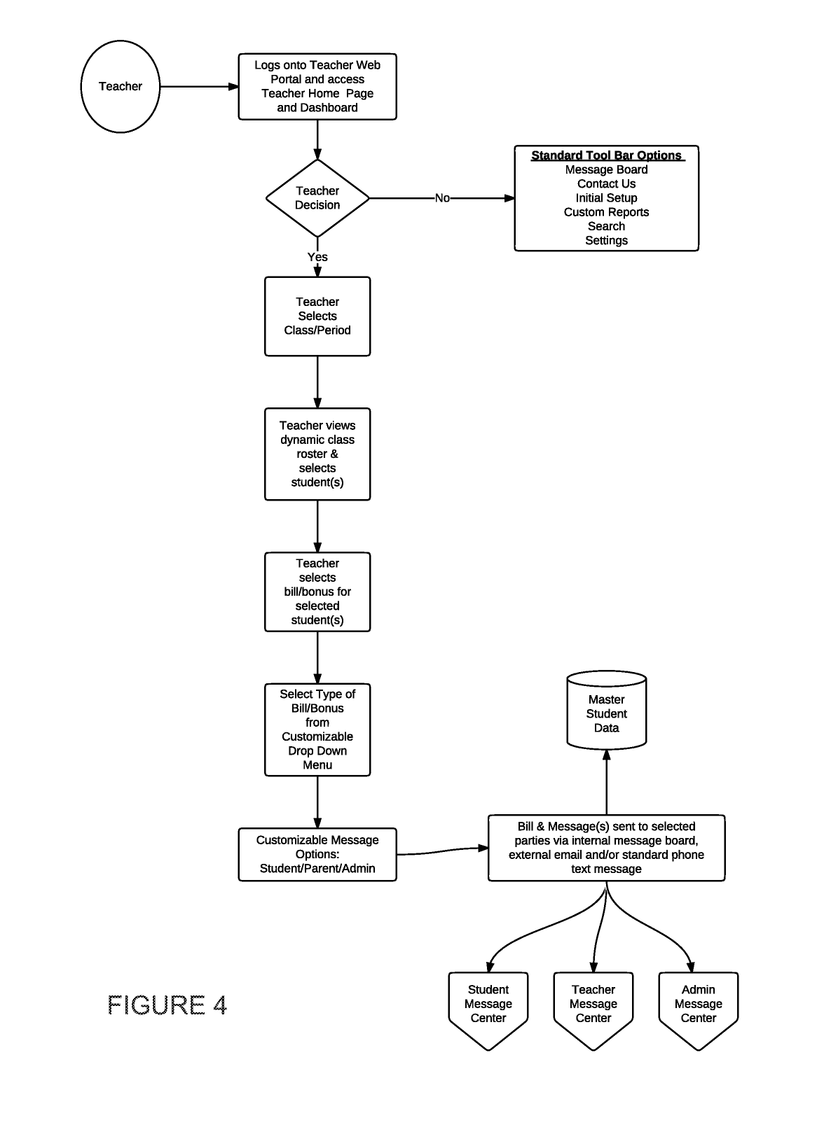

FIG. 5 illustrates a flowchart corresponding to an exemplary administrative user interface in accordance with classroom management and educational systems and methods described herein. More specifically, this figure illustrates the steps undergone when a teacher performs the initial set-up.

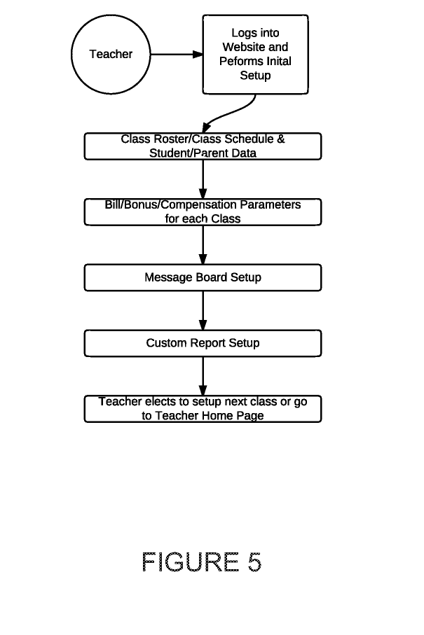

FIG. 6 illustrates an exemplary master ledger in accordance with classroom management and educational systems and methods described herein.

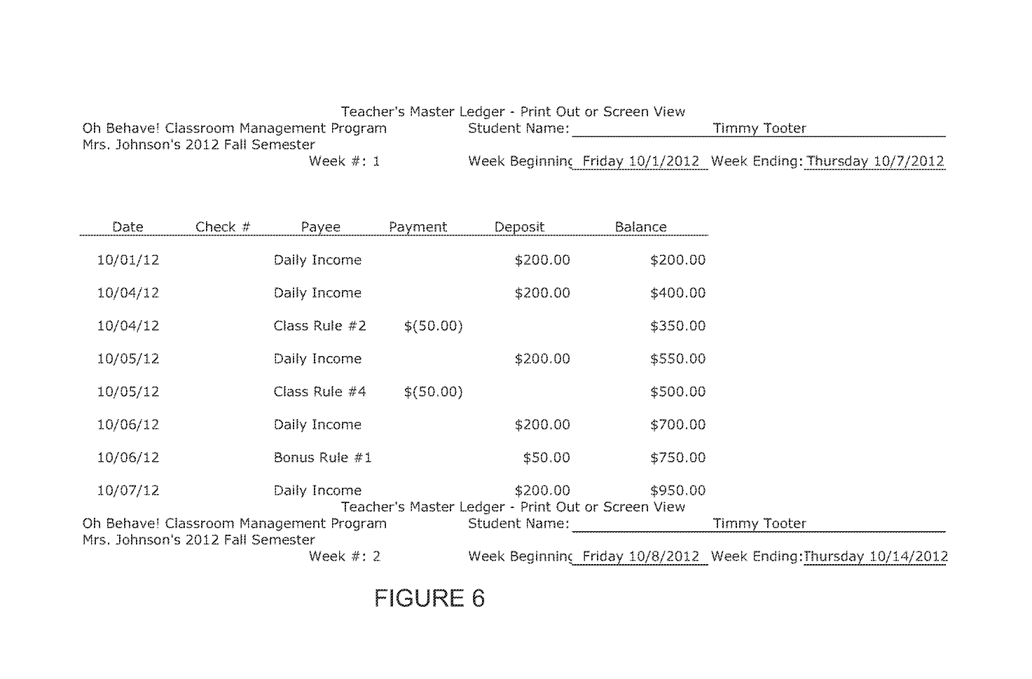

FIG. 7 illustrates an exemplary student ledger in accordance with classroom management and educational systems and methods described herein.

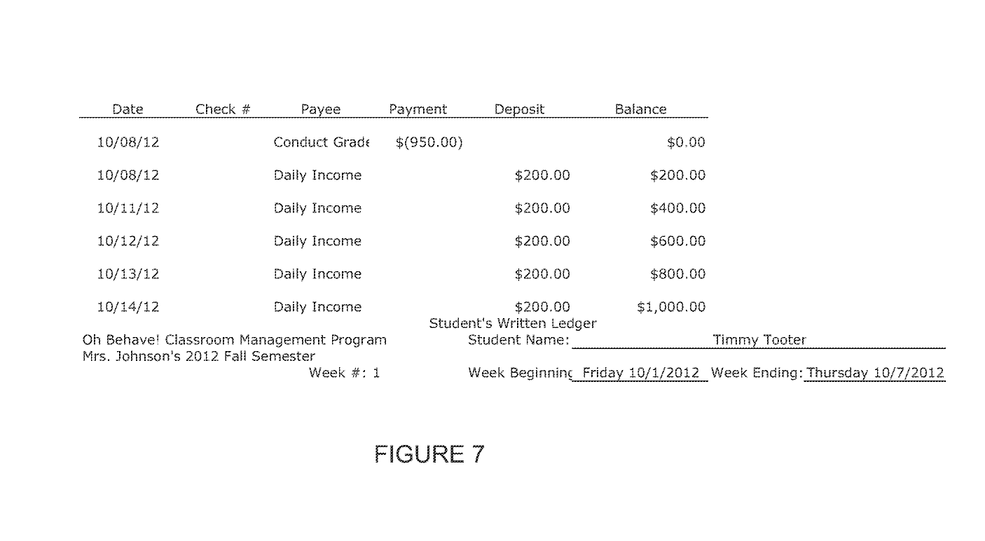

FIG. 8 illustrates an exemplary student ledger in accordance with classroom management and educational systems and methods described herein.

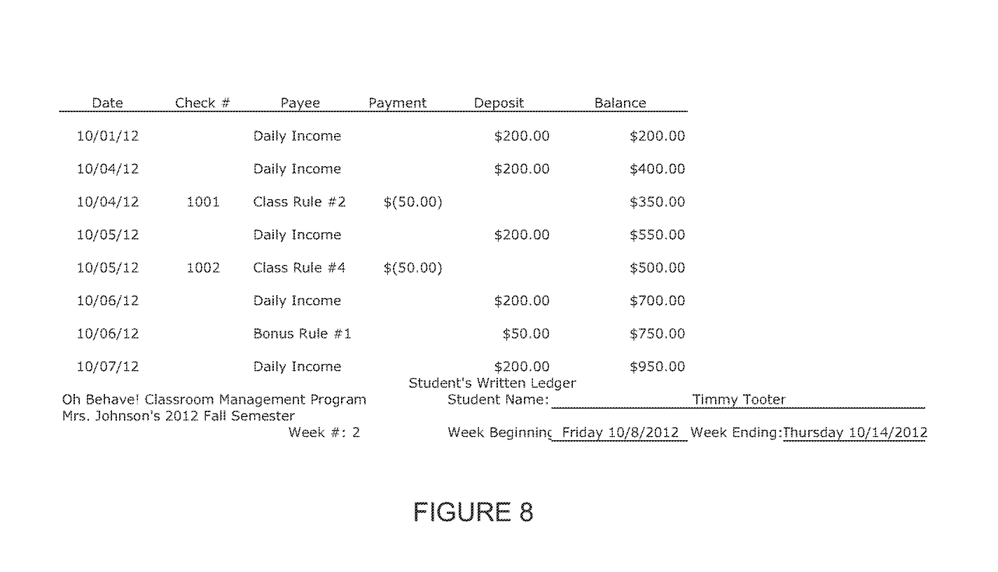

FIG. 9 illustrates an exemplary student ledger in accordance with classroom management and educational systems and methods described herein.

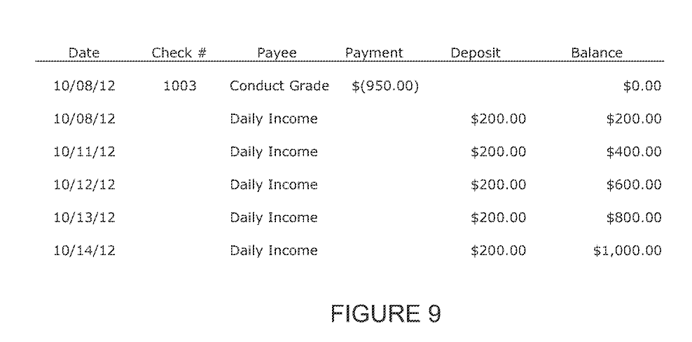

FIG. 10 illustrates an exemplary tangible credit or bill in accordance with classroom management and educational systems and methods described herein.

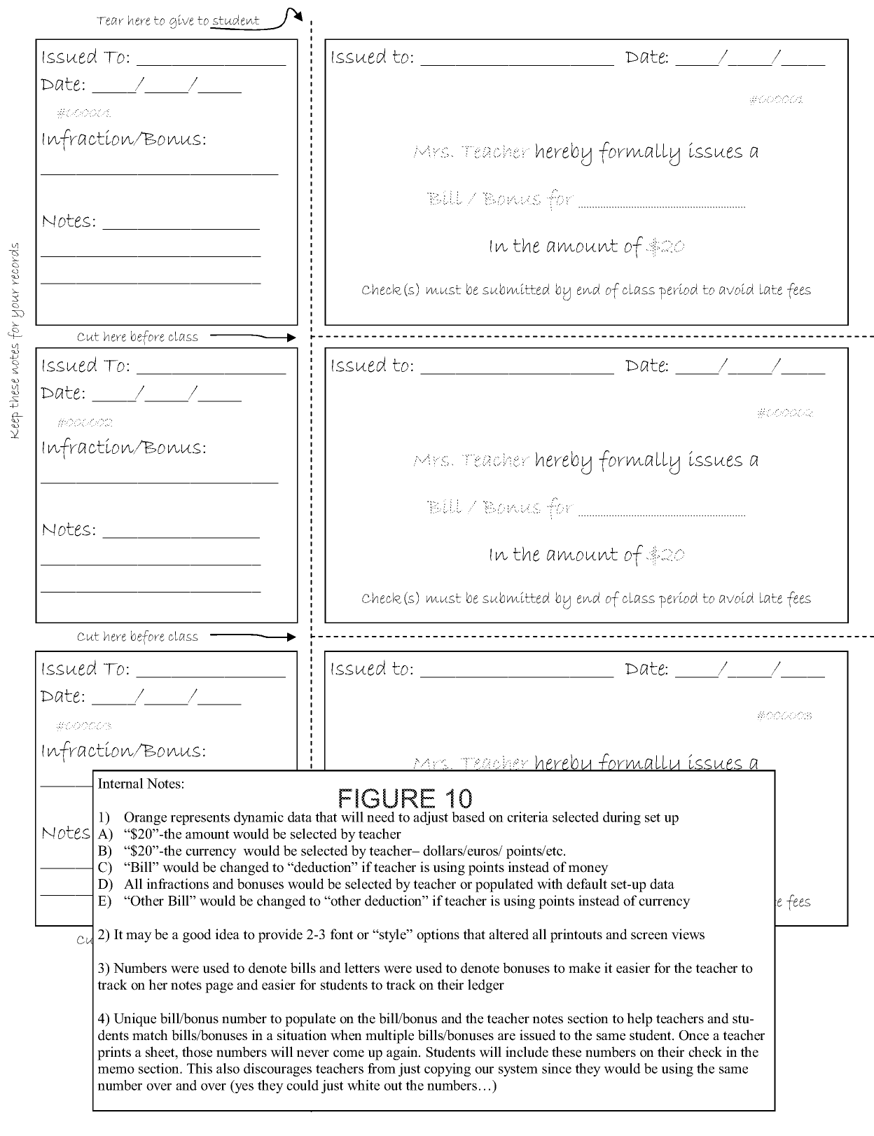

FIG. 11 illustrates a general-purpose computer and peripherals that when programmed as described herein may operate as a specially programmed computer capable of implementing one or more methods, apparatus and/or systems in accordance with classroom management and educational systems and methods described herein.

### DETAILED DESCRIPTION

Classroom management and educational systems and methods will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

Overview

In one or more embodiments, students will receive, use, and maintain checkbook registers, checks, deposit slips, mock checking account, and mock savings account. Alternatively, students may maintain their accounts through a user interface, such as but not limited to a user interface that includes a checking ledger. The student may maintain a checkbook ledger manually, which may be verified against an electronic system ledger.

For example, students may receive a deposit at the beginning of each school day. In one or more embodiments, students receive a credit bonus when caught demonstrating extraordinary behavior. Students may receive a bill for each infraction of a classroom expectation.

Students may be required to balance their physical or electronic checkbook and turn in payments/deposits at a regular period, such as by the end of each day.

Administrators or teachers may record all transactions for each student using the online accounts. The administrator or teacher may record such transactions on a regular period, such as daily.

The Program in Use

A teacher uses tear sheets to give bills and bonuses to students throughout the school day. In one or more embodiments, teachers have access to an electronic ledger for each student. This ledger may be automatically updated periodically with the student's daily income, determined during setup. In one or more embodiments, the ledger is updated periodically, for example, daily.

If a student receives a bill or bonus, the teacher enters the bill/bonus section of the website, selects the student from a drop down menu, then selects the corresponding bill or bonus given. The student's electronic ledger is automatically updated with the bill or bonus that the teacher has entered.

In one or more embodiments, the student is responsible for a manual written ledger. The student is responsible for entering the periodic income, for example, daily, amount onto the written ledger. If a student receives a bill from the teacher, the student must write a check for this infraction and submit it to teacher by a deadline, such as by the end of a class, day, or other period. The student is responsible for entering the check transaction onto the written ledger. If a student receives a bonus from the teacher, the student must enter this bonus onto the written ledger.

Ledger Reconciliation may be required periodically. For example, the period may correspond to a semester, quarter, month, week, pay period, or any other period.

At each pay period, the teacher's electronic student ledger for the prior pay period (which is printable) is compared to the student's written ledger for the prior pay period, both should be identical. In one or more embodiments, the ledger balance determines the pay period's conduct grade. The student is responsible for writing a check for the prior pay periods conduct grade. This conduct grade check transaction may be recorded on the student ledger periodically, such as at the beginning of a new pay period.

Each student will end the period by writing a check (electronically or by hand) made payable to a specified payee, for example, “Conduct” through the student's account (if electronically paid) using the bill pay feature. Due to the potential of bonuses, a student may accumulate more than a full period's pay by the period's end. Any surplus will be deposited by the student into his or her online savings account, thus zeroing out his or her checking account each period. Funds in the savings account can be used for certain “perks” as determined by the teacher. Each period, the student who accumulates the most savings will be recognized for the accomplishment, for example named the periodic “Tycoon” and will be recognized on all student's and parent's accounts.

The teacher closes out the prior pay period for each student by clicking on the designated button. This automatically updates the new pay period's electronic student ledger with the conduct grade payment.

When Teacher and Student reconcile their ledgers, the teacher electronically confirms that each outstanding bill has a corresponding check written by the student. When Teacher and Student reconcile their ledgers, any bill that has not yet been paid by the student can be marked on the electronic ledger as a late pay. This causes a late pay bill to be inputted onto the student's electronic ledger for the new pay period. The teacher gives the student a late pay bill. Once the student submits the checks for the original bill and late payment bill, the teacher confirms receipt of both through the teacher's electronic student ledger.

One or more embodiments may implement reporting to a parent, guardian or other party. For example, other teachers of the student, a principal, a counselor, or any other party may be registered as an authorized guardian user. At the end of the pay period, the teacher prints out a report that illustrates the conduct grade for each student. This can be provided to each parent via a take home folder (or if the parent prefers via email). Report would illustrate infractions and bonuses given during the pay period along with any additional comments the teacher wishes to express.

One or more embodiments may implement customized reporting capabilities. Through the reports function of the website, the teacher will have the ability to print out custom reports on a class and student level. Information available would be ledger balances, unpaid bills, conduct grade history, bonus history, savings account balances and reports as such.

Behavioral Expectations

Students help create and learn classroom expectations. The number of expectations may be limited and be presented in positive verbiage. For example, depending on the grade level of the student, the classroom expectations may be limited to 1-5. Additional classroom expectations may be added. Students learn the consequences of failing to meet the classroom expectations.

Exemplary expectations or other rules may include, but are not limited to: (1) Raise your hand for permission to speak (2) Raise your hand for permission to leave your seat (3) Follow directions the first time given (4) Use only constructive and positive words and actions and (5) Always have the appropriate materials organized at your desk.

Administrative User Interface: Teacher's Account

One or more embodiments provide an administrative user interface. The administrative user interface is accessible once the teacher or administrator subscribes to the program. The teacher or administrator first goes through an initial tutorial and setup process for functionality and access including but not limited Class Roster, Bill/Bonus/Compensation Parameters, Message Board and Custom Reports.

Once the class expectations are determined the teacher or administrator uses the account throughout the school day entering student bills and bonuses as necessary. Bills, bonuses, and compensation are automatically updated into each student's master checking account register which allows the teacher or administrator to compare her ledger with the student's online checking account register without any additional steps. This feature provides the teacher or administrator a quick method to assure students are updating their information accordingly.

The teacher's account is accessible once the teacher subscribes to the program. One or more teachers may be associated with each student. An initial setup may be performed to handle the following exemplary setup processes, which are neither all-inclusive nor limiting. Table 1 may include exemplary default values.

TABLE 1
Setup Processes with exemplary values

Class Setup (completed for each class)
Class Name
Start Date and End Date
Student Data (completed for each class)
Student name
Student ID/account number (will be auto populated)
Student group (if applicable- boys/girls. Table groups, etc . . .)
Parent contact info (if available)
Classroom Parameters (completed for each class)
Determine class pay period
Default: 5 Day period from Friday to Thursday
Ability to adjust length and start/end day
Determine daily student income
Dollar or Point System
Default: $200 per day
Default: 200 points per day
Ability to adjust dollar/points
Based on class pay period length, the total income/point potential
is calculated and illustrated
Determine Class Rules
5 Drop down boxes with pre-populated generic class rules to
choose from
Ability to add own rules
Ability to add more than 5 rules or less than 5 rules
Determine Cost of Infractions (Bills)
Default: $50/50 Points per infraction
Determine Conduct Grade
Based on Daily Income previously inputted
Defaults:
Exceptional (100% of pay period max)
Outstanding (90%-99% of pay period)
Satisfactory (80%-89% of pay period max)
Non-Satisfactory (0%-79% of pay period max)
Ability to adjust using a sliding scale
Ability to add additional categories
Determine Late Fee Penalty
Optional, Not Required
Default: $25 penalty for not paying bill prior to period end
Billed to student as a separate bill in the following period
Determine Bonus Parameters
3-5 Drop Down boxes with pre-populated generic class bonus
behaviors
Ability to add more or remove bonus behaviors
Determine Bonus Amounts
Default: $25/25 Points per infraction
Parent Letter Generator (explaining program)

Salary

Students are compensated on a daily basis as predetermined by the teacher. Each day the students enter their daily compensation into their written checkbook register which is then transferred by the student to his online checkbook register. By default, all students are assumed to receive a daily compensation unless a student has an unexcused absence. The daily compensation amount is established within the system during the teacher's initial setup process. Unless noted otherwise, the system automatically inputs the daily compensation into each student's master online checkbook register.

The teacher informs students of their daily “compensation” (i.e. $200 per day). If monetary compensation is not desirable, a point system can be used instead. In one or more embodiments, Students receive their paper checkbook register (paper/pencil) in which they input their daily compensation, bills, or bonuses. Alternatively, students may be authorized to balance an electronic checkbook ledger in a user interface.

Bills

Bills are given to a student when the student fails to meet the classroom expectations, and bonuses are given to a student who demonstrates behavior above and beyond the classroom expectations. Bonuses and bills may be issued by paper, electronically, or any combination thereof. Once all the parameters (I.E. expectations, consequences, compensation amount, student roster and parent contact information) are made, the teacher will enter them into the system via the teacher's account.

All student infractions are entered into the system regularly by the teacher, who may select the infraction from a preset menu created by the teacher/students during the initial set up process. A bill message is sent directly to the student's message center within the student's account. Teachers may also select an option for parents and administrators to receive a copy of the bill and the teacher's explanation to the student. A personalized message may be sent to the parent and administrator as well. Parents and/or administrators receive an email notification, for example, with a link prompting them to log into their account to view updated student account activity.

The student is required to pay his bill by the end of the period by either a handwritten check or through the student's account using the bill pay feature. The bill payment must then be reflected in the student's handwritten checking account register and in the student's online checking account register.

Bonuses

Students also have the opportunity to earn bonuses for positive or outstanding behavior as an individual or by class. Students can receive an additional bonus for exceptional class behavior/production, such as 100% homework turn-in or high percentage test grades.

In one or more embodiments, a student may be assigned as the class PI (Private Investigator) and has the task of documenting in the “Classroom PI Notebook” 5 students' names who are caught exhibiting outstanding behavior, or behavior described as going above and beyond. These five students, in addition to the PI of the day, receive a bonus payment to be deposited by the end of that day (electronically or by hand into the students' payment box).

The teacher records all bonuses into the system via the teacher's web portal. Once the student is selected, a bonus message is sent directly to the student's message center within the student's web portal with the option to send to the parent and/or administrator web portals. For efficiency, teachers can select multiple students or the whole class with one click. The bonus message is then sent to all selected students and parents/administrators.

Reconciliation

By a specific point of the period (determined by the teacher) all students must have updated their online checkbook register by using their written checkbook register. The system will automatically calculate any differences between the teacher's master register and student registers, which the teacher can view in their account.

Conduct Grade

At the end of the period, the student uses the balance in his checking account to purchase his period Conduct Grade. The period conduct grade is communicated authorized receivers.

Once the class parameters and student data has been inputted the teacher will then have access to the following resources, which may be provided either electronically or printed. Table 2 is non-limiting list of exemplary resources accessible to the administrative user or teacher.

Savings Account

One or more embodiments implement a savings account. If a student during the pay period accumulates an amount more than the max pay period income amount, this excess cash/points, shall be transferred to a student savings account. The student writes a check to savings and submits it to the teacher along with the student's conduct grade for that pay period. When a teacher closes out the prior pay period for each student, any excess amount above the max pay period income amount will automatically flow to the student's savings account. This transfer to savings may be automatically inputted onto the electronic student's ledger.

TABLE 2
exemplary resources

Student Ledgers
Class Name (pre-populated)
A full set of ledgers for each time period (i.e. If teacher inputs Start Date
of Sep. 5, 2011 and end date of Dec. 15, 2011 and this is equivalent to 15
weeks, then a full set of ledgers for each student is 15 ledgers each
numbered Week 1 through Week 15.
Student Checks
Class Name (pre-populated)
Student Name (pre-populated)
One page may contain 3 or 6 checks
Student cuts out check when ready to submit to teacher
Bill/Bonus Tear Sheets
Page that holds 3 sheets that can be cut out by the teacher and given to
a student when an infraction (bill) or bonus behavior occurs
Provides a method for the teacher to keep track of bills and bonuses
Bill Behavior Reminder Chart
Based on parameters determined in setup
Ability to print a one page chart that illustrates the rules of the class
Bonus Behavior Reminder Chart
Based on parameters determined in setup
Ability to print a one page chart that illustrates the bonus behaviors
Checking writing examples for students

Student User Interface (Student's Account)

The student's account is accessible once the teacher or administrator provides the student with authorization, such as a log in and password. Through the student account, the student receives teacher or administrator communications including, but not limited to, information regarding Bills, Bonuses, and Class Announcements, uses the bill pay feature to pay any outstanding bills and to purchase the period conduct grade, updates his or her online checking account register, views his or her personal historical classroom behavior (i.e. past bills, bonuses, conduct grades, etc), and performs other functionality.

Guardian User Interface (Parent's Account)

The parent's account is accessible once the teacher provides the parent with authorization, such as a log in and password. Through the parent account, the parent receives teacher communications regarding Bills, Bonuses, and Class Announcements, views child's online checking account with real time behavior “bills” or “bonuses”, views child's historical classroom behavior (i.e. past bills, bonuses, conduct grades), and may use an optional at home reward program

In one or more embodiments, parents or guardians are notified that the student will have the opportunity to earn and manage money in a mock checking and savings account. An exemplary notification may state: “In addition to the obvious benefits of learning to manage and budget money, your child will also take full responsibility for his or her actions by earning “bonuses” for extraordinary behavior and paying from his or her checking account when “billed” for classroom expectation infractions, similar to traffic ticketing. Your child will keep and balance a checkbook of behavior points (given in dollar amounts) that will be used to determine his or her conduct grade each period. You will receive a periodic printout of your child's progress.”

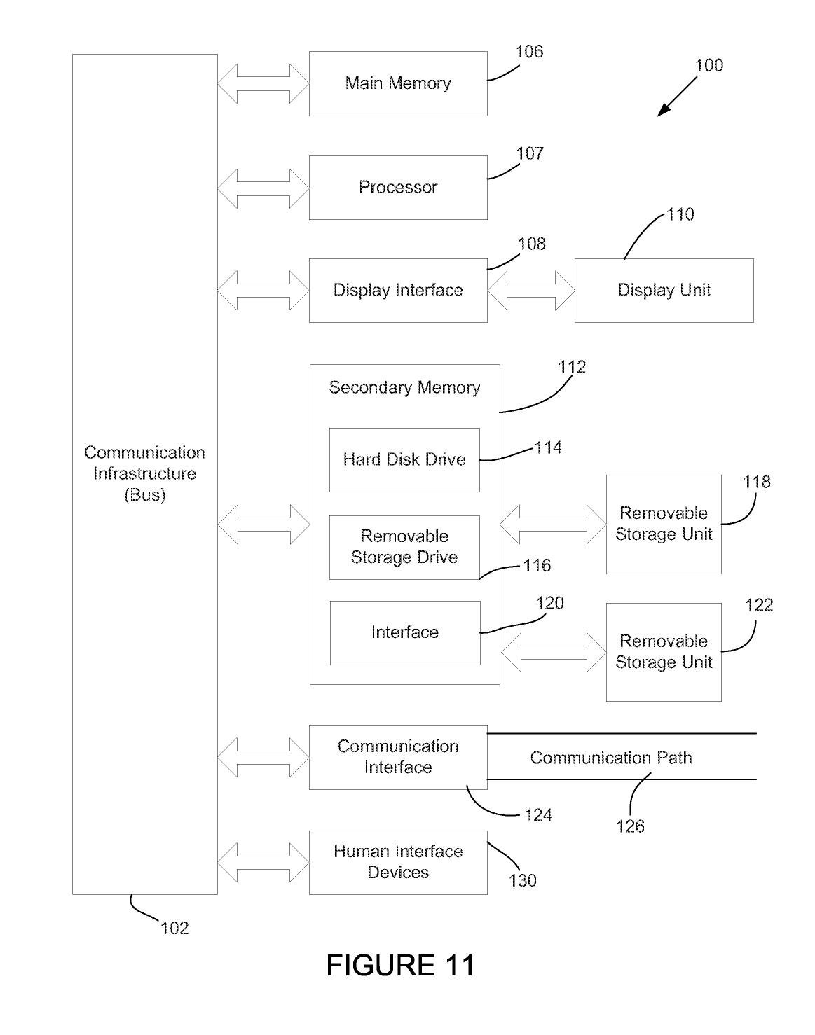

FIG. 11 diagrams a general-purpose computer and peripherals, when programmed as described herein, may operate as a specially programmed computer capable of implementing one or more methods, apparatus and/or systems of the solution described in this disclosure. Processor 107 may be coupled to bi-directional communication infrastructure 102 such as communication infrastructure system bus 102. Communication infrastructure 102 may generally be a system bus that provides an interface to the other components in the general-purpose computer system such as processor 107, main memory 106, display interface 108, secondary memory 112 and/or communication interface 124.

Main memory 106 may provide a computer readable medium for accessing and executed stored data and applications. Display interface 108 may communicate with display unit 110 that may be utilized to display outputs to the user of the specially-programmed computer system. Display unit 110 may comprise one or more monitors that may visually depict aspects of the computer program to the user. Main memory 106 and display interface 108 may be coupled to communication infrastructure 102, which may serve as the interface point to secondary memory 112 and communication interface 124. Secondary memory 112 may provide additional memory resources beyond main memory 106, and may generally function as a storage location for computer programs to be executed by processor 107. Either fixed or removable computer-readable media may serve as Secondary memory 112. Secondary memory 112 may comprise, for example, hard disk 114 and removable storage drive 116 that may have an associated removable storage unit 118. There may be multiple sources of secondary memory 112 and systems implementing the solutions described in this disclosure may be configured as needed to support the data storage requirements of the user and the methods described herein. Secondary memory 112 may also comprise interface 120 that serves as an interface point to additional storage such as removable storage unit 122. Numerous types of data storage devices may serve as repositories for data utilized by the specially programmed computer system. For example, magnetic, optical or magnetic-optical storage systems, or any other available mass storage technology that provides a repository for digital information may be used.

Communication interface 124 may be coupled to communication infrastructure 102 and may serve as a conduit for data destined for or received from communication path 126. A network interface card (NIC) is an example of the type of device that once coupled to communication infrastructure 102 may provide a mechanism for transporting data to communication path 126. Computer networks such Local Area Networks (LAN), Wide Area Networks (WAN), Wireless networks, optical networks, distributed networks, the Internet or any combination thereof are some examples of the type of communication paths that may be utilized by the specially program computer system. Communication path 126 may comprise any type of telecommunication network or interconnection fabric that can transport data to and from communication interface 124.

To facilitate user interaction with the specially programmed computer system, one or more human interface devices (HID) 130 may be provided. Some examples of HIDs that enable users to input commands or data to the specially programmed computer may comprise a keyboard, mouse, touch screen devices, microphones or other audio interface devices, motion sensors or the like, as well as any other device able to accept any kind of human input and in turn communicate that input to processor 107 to trigger one or more responses from the specially programmed computer are within the scope of the system disclosed herein.

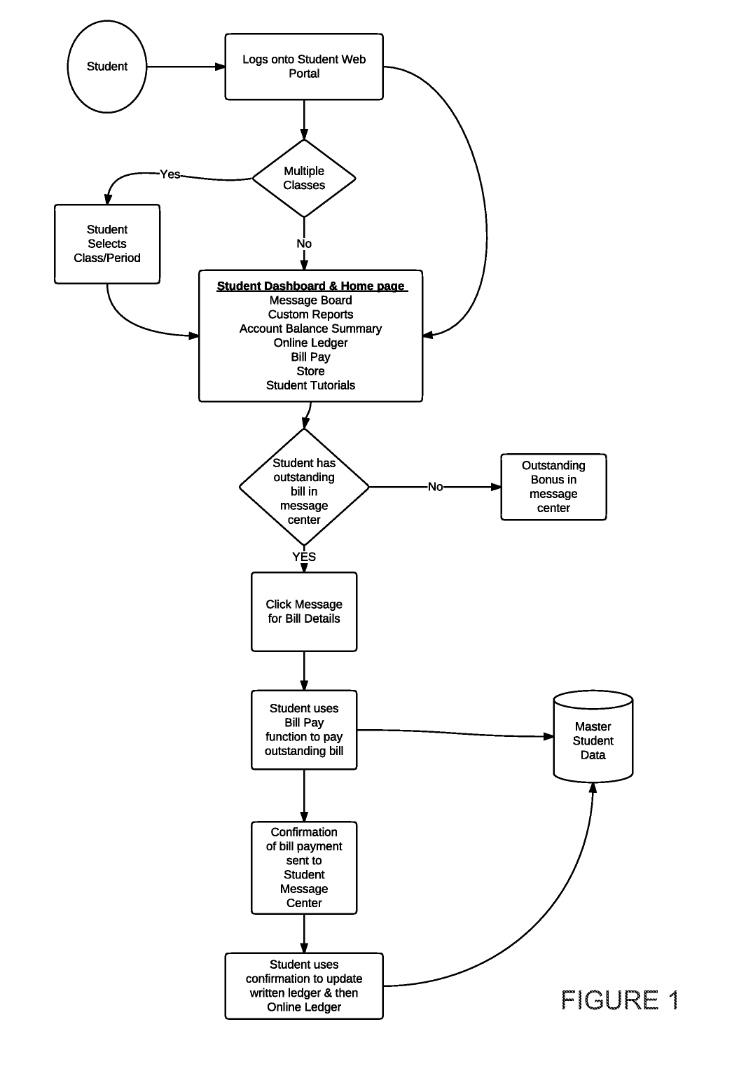

While FIG. 1 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. In one or more embodiments, the system may also encompass parallel systems, multi-processor systems, multi-core processors, and/or any combination thereof. Where a virtual machine, process, device or otherwise performs substantially similarly to that of a physical computer system, such a virtual platform will also fall within the scope of disclosure provided herein, notwithstanding the description herein of a physical system such as that in FIG. 1.

One or more embodiments are configured to enable the specially programmed computer to take the input data given and transform it into a web-based UI by applying one or more of the methods and/or processes described herein. Thus the methods described herein are able to transform a stored component into a web UI, using the solution disclosed here to result in an output of the system as a web UI design support tool, using the specially programmed computer as described herein.

While the invention herein disclosed has been described by means of specific embodiments and applications thereof, numerous modifications and variations could be made thereto by those skilled in the art without departing from the scope of the invention set forth in the claims.

What is claimed is:

1. A computer-readable medium comprising computer-readable instructions for a classroom management system, wherein execution of the computer-readable instructions by one or more processors causes the one or more processors to execute steps comprising:
accessing a database comprising a plurality of student behavior accounts;
authenticating an authorized administrative user;
accepting one or more modifications by the authorized administrative user to a selected student behavior account selected from the plurality of student behavior accounts, wherein the one or modifications are selected from crediting the selected student behavior account and billing the selected student behavior account;
authenticating an authorized student user;
accepting one or more operations by the authorized student user, wherein the one or more operations are selected from paying a bill with credits and purchasing a conduct grade with credits;
modifying a student behavior account associated with the authorized student user in the database based on the one or more operations; and
generating a plurality of conduct reports based on a plurality of purchased conduct grades.

2. The computer-readable medium of claim 1, wherein the steps further comprise:
authenticating an authorized guardian user associated with a student user;
providing information stored in the database in a student behavior account associated with the student user to the authorized guardian user.

3. The computer-readable medium of claim 2, wherein the information comprises a conduct grade purchased by the student user.

4. The computer-readable medium of claim 2, wherein the information comprises historical classroom behavior data.

5. The computer-readable medium of claim 2, further comprising the step of providing a guardian user interface to the authorized guardian user.

6. The computer-readable medium of claim 1, further comprising the step of notifying a guardian party associated with the authorized student user when a conduct grade is purchased.

7. The computer-readable medium of claim 1, wherein the one or more modifications are further selected from adding a student, removing a student, clearing a student behavior account, and assigning an association between a student behavior account and one or more authorized administrative user.

8. The computer-readable medium of claim 1, wherein the one or more modifications are further selected from adding a student, removing a student, clearing a student behavior account, and assigning an association between a student behavior account and one or more authorized administrative user.

9. The computer-readable medium of claim 1, further comprising the step of providing an administrative user interface to the authorized administrative user.

10. The computer-readable medium of claim 1, further comprising the step of providing a student user interface to the authorized student user.

11. The computer-readable medium of claim 10, wherein the student user interface comprises an interactive checking account ledger.

12. A classroom management system comprising:
a behavior data module configured to store a plurality of student behavior accounts in a database, wherein the student behavior accounts comprise credits earned by an associated student and bills charged to the associated student;
a teacher access module configured to accept one or more modifications to a selected student behavior account, wherein the one or more modifications are selected from crediting the selected student behavior account and billing the selected student behavior account; and
a student access module configured to accept one or more operations, wherein the one or more operations are selected from paying a student bill with credits from a student behavior account and purchasing a conduct grade with credits.

13. The classroom management system of claim 12, further comprising:
a guardian access module configured to provide information stored in the database in an associated student behavior account to the a guardian user.

14. The classroom management system of claim 13, wherein the information comprises a conduct grade purchased by the student user.

15. The classroom management system of claim 13, wherein the information comprises historical classroom behavior data.

16. The classroom management system of claim 12, wherein a guardian party is notified when a conduct grade is purchased.

17. The classroom management system of claim 12, wherein the one or modifications are further selected from adding a student, removing a student, clearing a student behavior account, and assigning an association between a student behavior account and one or more authorized administrative user.

18. The classroom management system of claim 12, wherein the one or modifications are further selected from adding a student, removing a student, clearing a student behavior account, and assigning an association between a student behavior account and one or more authorized administrative user.

19. The classroom management system of claim 12, wherein the student access module comprises user interface comprising an interactive checking account ledger.

20. The classroom management system of claim 12, wherein the student access module is further configured to verify a manually computed checking account ledger.
